(19) United States
(12) Patent Application Publication
(10) Pub. No.: US 2004/0236834 A1
(43) Pub. Date: Nov. 25, 2004

(54) Delivery of wireless email based on user viewing interest

(75) Inventor: Stuart Sherman Kreitzer, Coral Springs, FL (US)

Correspondence Address: FLEIT, KAIN, GIBBONS, GUTMAN, BONGINI, & BIANCO P.L., 551 N.W. 77TH STREET, SUITE 111, BOCA RATON, FL, 33487, US

(73) Assignee: MOTOROLA, INC., SCHAUMBURG, IL

(21) Appl. No.: 10/443,222

(22) Filed: May 22, 2003

(51) Int. Cl. G06F 15/16

(52) U.S. Cl. 709/206

(57) ABSTRACT

Disclosed is a system (100), method and computer program product for facilitating wireless transmission of email messages. The method on a wireless device (106) includes storing a user's email viewing interest profile (110) and receiving a first portion of a wirelessly transmitted email message. The method further includes wirelessly transmitting a request for transmission of a second portion of the wirelessly transmitted email message in response to determining that the stored user's email viewing interest profile (110) indicates a user's interest in receiving a second portion of the wirelessly transmitted email message. The stored user's email viewing interest profile (110) associates a measure of a user's viewing interest with key field information of an email message.

### FIELD OF THE INVENTION

The present invention generally relates to the field of wireless communications, and more particularly relates to email exchange between wireless devices.

### BACKGROUND OF THE INVENTION

With the advent of pagers and mobile phones the wireless service industry has grown into a multi-billion dollar industry. Recently, email and messaging functionality over wireless devices has grown in popularity. Having access to messages on a wireless device allows a user to stay connected while on the go and eliminates the need for frequent trips to a workstation or other landline-connected network. In addition, email and messaging functionality over a wireless device provides users with added communication abilities when traveling or otherwise on the road. Email over a wireless device, however, does not come without its drawbacks.

Bandwidth is a scarce commodity in the wireless networks industry. Thus, providers are constantly seeking ways to reduce the amount of bandwidth necessary to provide adequate communications services to its providers. With regards to email and messaging capabilities over wireless networks, there are generally two types of services that are currently available. Pull email is a system whereby a user routinely wirelessly requests messages from the messaging server. As the user brings a wireless device online, the device sends a request for messages to the server. This paradigm saves bandwidth at first, as the email server only sends messages to the user in response to user requests. This solution, however, can be tedious and high maintenance for users, as it requires users to constantly request messages from the server. Users prefer to have messages available to them as soon as possible.

Push email is a system whereby the messaging server wirelessly sends messages to the users as it receives them. As the user brings a wireless device online, the server immediately sends any messages it has to the wireless device. This paradigm, however, disregards bandwidth conservation as the email server sends all messages to the user whether the user wants them or not. Another feature to the push email system includes having the email server send one block, chunk or portion of each message to the user device. As the user reviews each message, the user can manually request additional portions of the message. This paradigm saves bandwidth at first, as the email server initially only sends one portion of each message to the user. This solution, however, can be tedious and high maintenance, as it requires users to constantly request additional portions of messages from the server. Users prefer to have messages of high interest available in their entirety as soon as possible.

Therefore a need exists to overcome the problems with the prior art as discussed above.

### SUMMARY OF THE INVENTION

Briefly, in accordance with the present invention, disclosed is a system, method and computer program product for facilitating wireless transmission of email messages. In an embodiment of the present invention, the method on a wireless device includes storing a user's email viewing interest profile and receiving a first portion of a wirelessly transmitted email message. The method further includes wirelessly transmitting a request for transmission of a second portion of the wirelessly transmitted email message in response to determining that the stored user's email viewing interest profile indicates a user's interest in receiving a second portion of the wirelessly transmitted email message.

In another embodiment of the present invention, the method on a central email server includes uploading to a central email server a user's email viewing interest profile and storing the user's email viewing interest profile. The method further includes receiving an email message for the user and wirelessly transmitting a predefined portion of the email message in response to determining that the stored user's email viewing interest profile indicates a user's interest in receiving a predefined portion of the email message.

In another embodiment of the present invention, a wireless device for facilitating wireless transmission of email messages is disclosed. In an embodiment of the present invention, the wireless device includes a storage element for storing a user's email viewing interest profile and a receiver for receiving a first portion of a wirelessly transmitted email message. The wireless device further includes a processor for determining that the stored user's email viewing interest profile indicates a user's interest in receiving a second portion of the wirelessly transmitted email message and a transmitter for wirelessly transmitting a request for transmission of a second portion of the wirelessly transmitted email message.

The embodiments of the present invention are advantageous as they allow for an adaptive email viewing interest routine that allows for automatic reception of high interest email messages by the user. This is beneficial as the adaptive routine is constantly gathering statistics regarding a user's email viewing interest and thus provides a highly customizable and personal service to the user. The statistics that are gathered include a correspondence between user interest and any information field of an email message.

Additionally, the present invention is advantageous because it saves bandwidth by automatically arranging the transmission of high interest email messages to the user. Only one block or chunk of low interest email messages is received by the user initially. The user must request additional portions of low interest email messages from the email server. Thus, additional portions of email messages that are never opened or viewed by the user are never requested by the user and thus are never sent to the user by the email server.

The embodiments of the present invention are also advantageous as the adaptive routine allows for customization of the size of additional message portions sent to the user. As explained above, only one block or chunk of low interest email messages are received by the user initially. However, email messages of high interest are automatically received by the user. The adaptive routine of the present invention adaptively adjusts the sizes of additional message portions sent to the user. This is beneficial as it saves bandwidth by sending only enough data as is necessary.

### BRIEF DESCRIPTION OF THE DRAWINGS

FIG. 1 is a block diagram illustrating a wireless communication system according to a preferred embodiment of the present invention.

FIG. 2 is a more detailed block diagram of the wireless communication system of FIG. 1.

FIG. 3 is a detailed block diagram of a wireless device in FIG. I according to a preferred embodiment of the present invention.

FIG. 4 is a more detailed block diagram of an email server for the wireless communication system of FIG. 1, in accordance with a preferred embodiment of the present invention.

FIG. 5 is a diagram representation of an exemplary email message.

FIG. 6 is an operational flow diagram illustrating a prior art process for wireless push email delivery.

FIG. 7 is an operational flow diagram illustrating a prior art process for wireless pull email delivery.

FIG. 8 is an operational flow diagram showing an adaptive wireless email delivery process implemented in a wireless device, according to a preferred embodiment of the present invention.

FIG. 9 is an operational flow diagram showing an adaptive wireless email delivery process implemented in an email server and wireless device in a wireless communication system, according to a preferred embodiment of the present invention.

FIG. 10 is an operational flow diagram showing a learning process by an adaptive wireless email delivery system, according to a preferred embodiment of the present invention.

FIG. 11 is an operational flow diagram showing an adaptive wireless email delivery process implemented in a wireless device, according to a preferred embodiment of the present invention.

FIG. 12 is an operational flow diagram showing an adaptive wireless email delivery process implemented in an email server, according to a preferred embodiment of the present invention.

FIG. 13 is an operational flow diagram showing a process for using a user email viewing interest database, according to a preferred embodiment of the present invention.

FIG. 14 is a block diagram showing a computer system useful for implementing an embodiment of the present invention.

### DETAILED DESCRIPTION

The present invention, according to a preferred embodiment, overcomes problems with the prior art by eliminating the need for users to repeatedly manually request more portions of wireless email messages while maintaining efficient channel throughput for a wireless system.

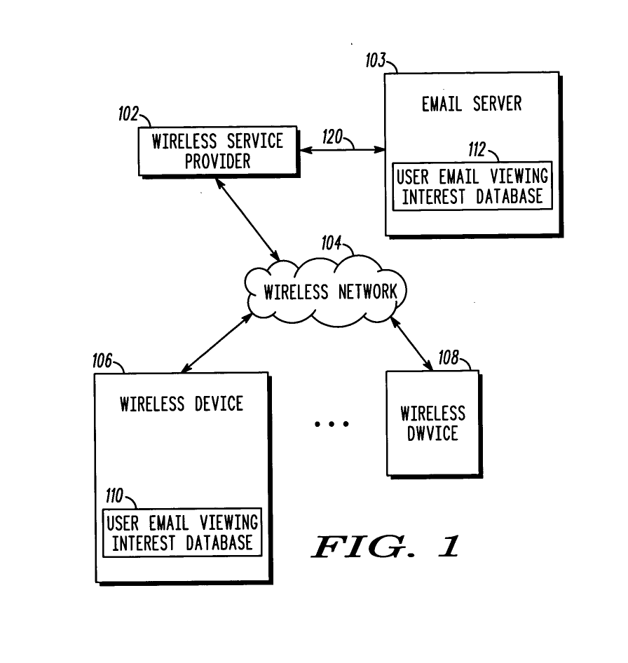

FIG. 1 is a block diagram illustrating a wireless communication system according to a preferred embodiment of the present invention. The exemplary wireless communication system of FIG. 1 includes a wireless service provider 102, a wireless network 104 and wireless devices 106 through 108. The wireless service provider 102 is a first-generation analog mobile phone service, a second-generation (2G) digital mobile phone service (including 2.5G and 2.75G) or a third-generation (3G) Internet-capable mobile phone service. The exemplary wireless network 104 is a mobile phone network, a mobile text messaging device network, a pager network, or the like. Further, the communications standard of the wireless network 104 of FIG. 1 is Code Division Multiple Access (CDMA), Time Division Multiple Access (TDMA), Global System for Mobile Communications (GSM), General Packet Radio Service (GPRS), Frequency Division Multiple Access (FDMA) or the like.

The wireless network 104 supports any number of wireless devices 106 through 108, which are mobile phones, push-to-talk mobile radios, text messaging devices, handheld computers, two way pagers, one way pagers, or the like. Wireless device 106 includes a user email viewing interest database 110, which is a data repository for holding information associated with the email viewing interests of a user of wireless device 106. The information stored in the user email viewing interest database 110 is described in greater detail below.

FIG. 1 also shows email server 103 connected to the wireless service provider 102 via a connection 120. The connection 120 comprises any one or any combination of a Local Area Network (LAN), a Wide Area Network (WAN), a Public Switched Telephone Network (PSTN), a dedicated line, or the like. The email server 103 comprises any commercially available email or messaging server, such as Microsoft Exchange Server available from Microsoft Corporation of Redmond, Wash. Email server 103 includes a user email viewing interest database 110, which in this example comprises a data repository for holding information associated with the email viewing interests of a user of wireless device 106. The information stored in the user email viewing interest database 110 is described in greater detail below. The email server 103 is also described in greater detail below.

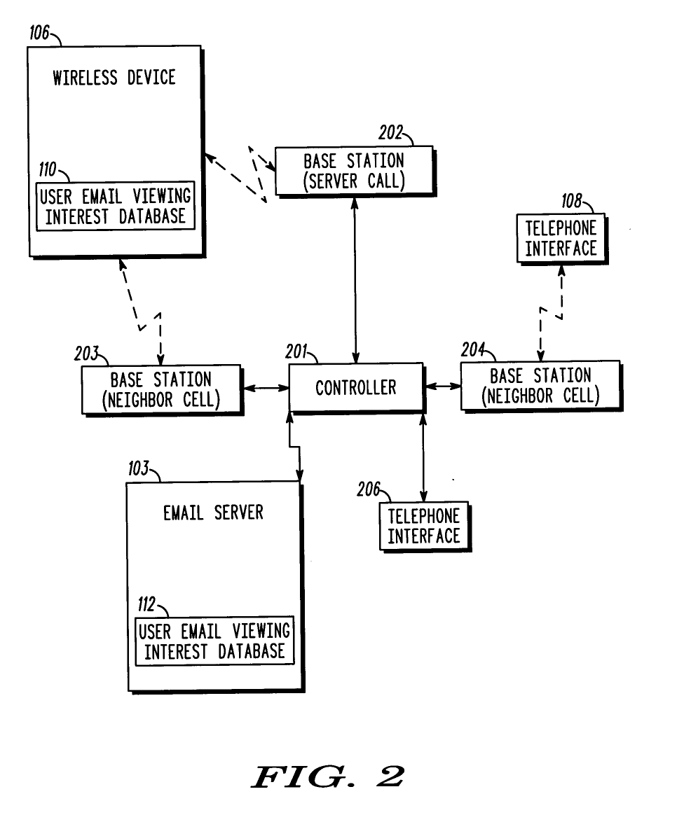

FIG. 2 is a more detailed block diagram of the wireless communication system of FIG. 1. The wireless communication system of FIG. 2 includes a controller 201 coupled to base stations 202, 203, 204. In addition, the wireless communication system of FIG. 2 is interfaced to an external network through a telephone interface 206. The base stations 202, 203, 204 individually support portions of a geographic coverage area containing subscriber units or transceivers (i.e., wireless devices) 106 and 108 (see FIG. 1). The wireless devices 106 and 108 interface with the base stations 202, 203, 204 using a communication protocol, such as CDMA, FDMA, CDMA, GPRS or GSM. FIG. 2 also shows email server 103 of FIG. 1 connected to the controller 201. The email server 103 is described in greater detail below.

The geographic coverage area of the wireless communication system of FIG. 2 is divided into regions or cells, which are individually serviced by the base stations 202, 203, 204 (also referred to herein as cell servers). A mobile device, such as wireless devices 106 and 108, operating within the wireless communication system selects a particular cell server as its primary interface for receive and transmit operations within the system. For example, wireless device 106 has cell server 202 as its primary cell server, and wireless device 108 has cell server 204 as its primary cell server. Preferably, a wireless device selects a cell server that provides the best communication interface into the wireless communication system. Ordinarily, this will depend on the signal quality of communication signals between a wireless device and a particular cell server.

As a wireless device moves between various geographic locations in the coverage area, a hand-off or hand-over may be necessary to another cell server, which will then function as the primary cell server (for example, a hand-off between cell server 202 and 203). A wireless device monitors communication signals from base stations servicing neighboring cells to determine the most appropriate new server for hand-off purposes. Besides monitoring the quality of a transmitted signal from a neighboring cell server, the wireless device also monitors the transmitted color code information associated with the transmitted signal to quickly identify which neighbor cell server is the source of the transmitted signal.

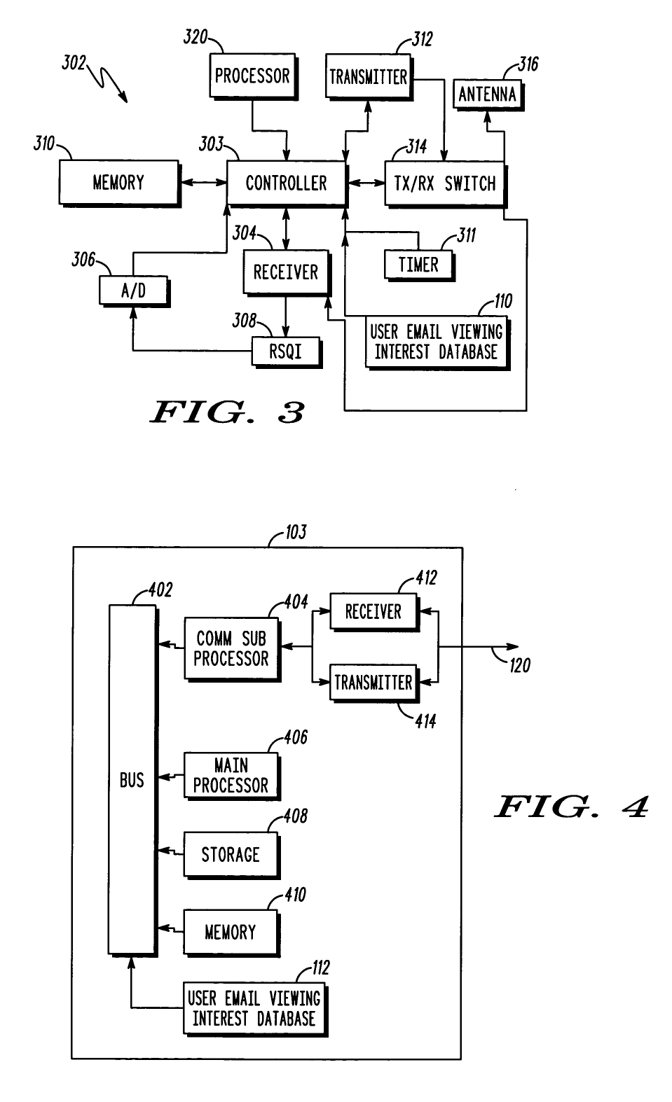

FIG. 3 is a block diagram illustrating a wireless device according to a preferred embodiment of the present invention. FIG. 3 shows a wireless device 302, such as wireless devices 106 through 108 of FIG. 1. In one embodiment of the present invention, the wireless device 302 is a two-way radio capable of receiving and transmitting radio frequency signals over a communication channel under a communications protocol such as CDMA, FDMA, CDMA, GPRS or GSM. The wireless device 302 operates under the control of a controller 303, which switches the wireless device 302 between receive and transmit modes. In receive mode, the controller 303 couples an antenna 316 through a transmit/receive switch 314 to a receiver 304. The receiver 304 decodes the received signals and provides those decoded signals to the controller 303. In transmit mode, the controller 303 couples the antenna 316, through the switch 314, to a transmitter 312.

The controller 303 operates the transmitter and receiver according to instructions stored in memory 310. These instructions include a neighbor cell measurement scheduling algorithm 319. In preferred embodiments of the present invention, memory 310 comprises any one or any combination of non-volatile memory, Flash memory or Random Access Memory. A timer module 311 provides timing information to the controller 303 to keep track of timed events. Further, the controller 303 can utilize the time information from the timer module 311 to keep track of scheduling for neighbor cell server transmissions and transmitted color code information.

When a neighbor cell measurement is scheduled, the receiver 304, under the control of the controller 303, monitors neighbor cell servers and receives a “received signal quality indicator” (RSQI). RSQI circuit 308 generates RSQI signals representing the signal quality of the signals transmitted by each monitored cell server. Each RSQI signal is converted to digital information by an analog-to-digital converter 306 and provided as input to the controller 303. Using the color code information and the associated received signal quality indicator, the mobile device 302 determines the most appropriate neighbor cell server to use as a primary cell server when hand-off is necessary.

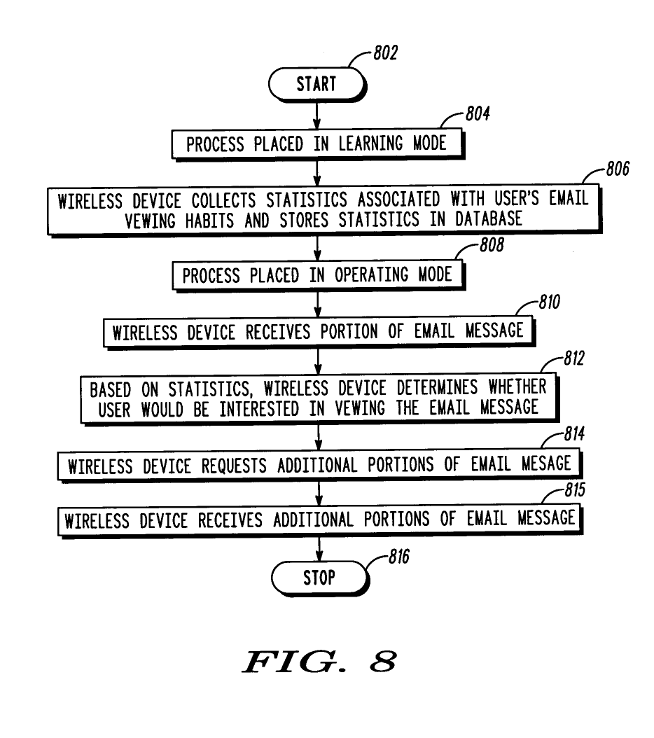

Processor 320 in FIG. 3 performs various functions such as the functions attributed to the adaptive email viewing interest routine, as described below with reference to FIGS. 8-13. In various embodiments of the present invention, the processor 320 in FIG. 3 comrpises a single processor or more than one processor for performing the tasks described below. FIG. 3 also includes a user email viewing interest database 110, which is a data repository for holding information associated with the email viewing interests of the user of wireless device 106. The information stored in the user email viewing interest database 110 is described in greater detail below.

FIG. 4 is a more detailed block diagram of the email server 103 for the wireless communication system of FIG. 1, in accordance with a preferred embodiment of the present invention. The email server 103 includes a receiver 412 and a transmitter 414 for sending and receiving information over a connection 120 that is connected to the wireless service provider 102. All information sent or received via the receiver 412 and transmitter 414 is processed by a communications sub-processor 404.

The email server 103 includes a main processor 406 that handles all processes associated with the message and email queuing, receiving and transmitting functions of the email server 103. FIG. 4 also includes a storage module 408 for storing information that may be used during the overall processes of the present invention. Email server 103 also includes a main memory module 410, such as a volatile memory element like a DRAM module or a non-volatile memory such as battery backup RAM or both. The main memory module 410 is used for storing and retrieving data and instructions necessary for performing the functions of email server 103.

Email server 103 may also include a user email viewing interest database 112, which is a data repository for holding information associated with the email viewing interests of a user with a wireless device, such as wireless device 106. The information stored in the user email viewing interest database 112 is described in greater detail below. Communications bus 402 provides a conduit for communications between communications sub processor 404, the main processor 406, the main storage element 410 and the user email viewing interest database 112.

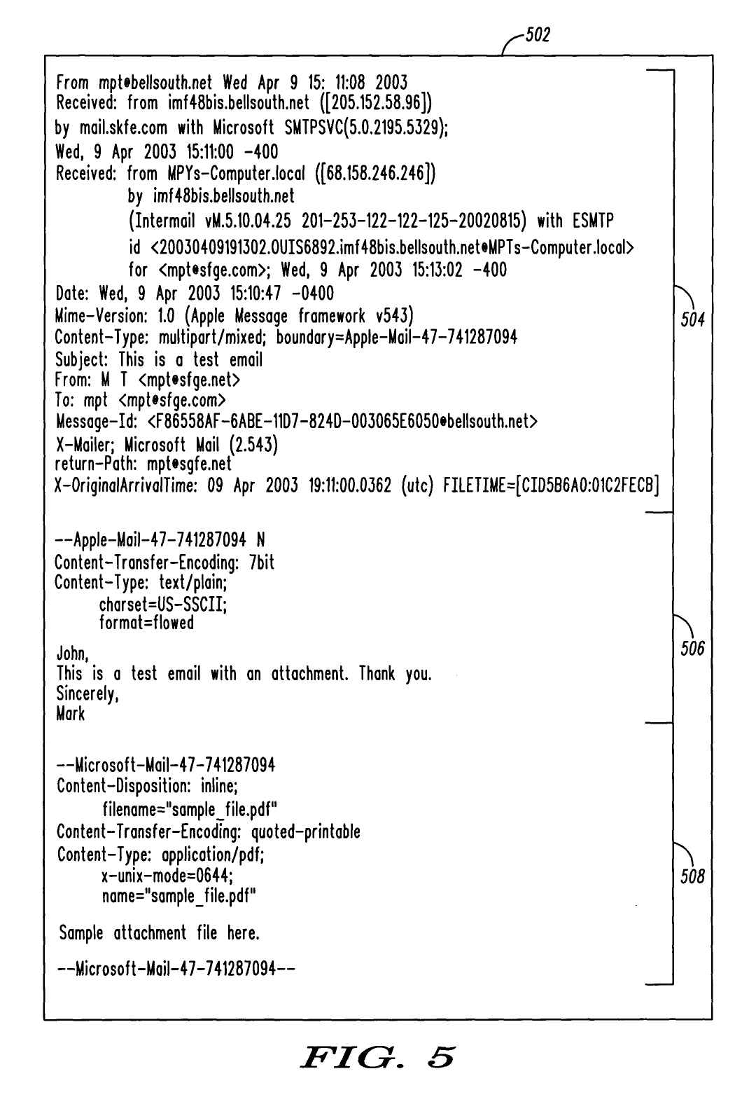

FIG. 5 is a diagram representation of an exemplary email message. FIG. 5 shows an email message 502 including three major elements: a header element 504, a body element 506 and an attachment element 508. The body element 506 and an attachment element 508 are referred to as the payload of the email message 502. The header element 504 includes information associated with the transmission of the email message 502. The header element 504 includes such information as the sender of the email message 502, the intended recipient of the email message 502, the subject of email message 502, the route that the email message 502 took during transmission to the recipient and the times associated with the location of the email message 502 at different times during transmission.

Email message 502 also includes a body element 506, which is typically where message text is included. Body element 506 of the email message 502 can be standard text or can be formulated in a particular format such as Hyper Text Markup Language (HTML). Email message 502 further includes attachment element 508, which typically holds a file or other data grouping that is separate from the data in the body element 506 of the email message 502. The data in the attachment element 508 can be viewed in the display portion of an email viewing application if the application is equipped to read the type of file or data grouping of the attachment element 508. For example, if an attachment element 508 is a Portable Document Format (PDF) format file, then the email viewing application must be equipped with a PDF viewing application or plug-in that aids the email viewing application in displaying the attachment element 508.

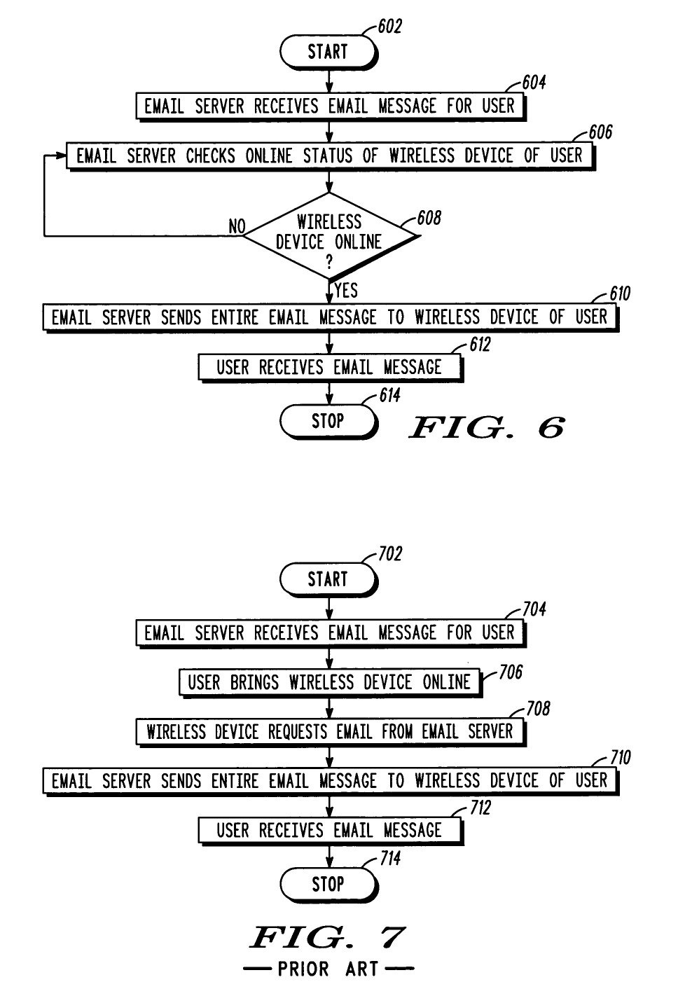

FIG. 6 is an operational flow diagram illustrating a prior art process for wireless push email delivery. The operational flow diagram of FIG. 6 shows a conventional process for delivering email messages to wireless devices using a push method. The operational flow diagram of FIG. 6 begins with step 602 and flows directly to step 604.

In step 604, the email server 103 receives an email message, such as email message 502, intended for the user of wireless device 106. In step 606, the email server 103 determines whether the wireless device 106 is online or currently in contact with the wireless network 104. In step 608, if the wireless device 106 is online or currently in contact with the wireless network 104, then control flows to step 610. If the wireless device 106 is not online or currently in contact with the wireless network 104, then control flows back to step 606.

In step 610, the email server 103 sends the entire email message 502 to the wireless device 106 via the wireless network 104. In one alternative, the email server 103 sends a first portion of the email message 502 to the wireless device 106 via the wireless network 104. Subsequently, if the user is interested in the email message 502, then the user must instruct the wireless device 106 to send a request to the email server 106 for additional portions of the email message 502.

In step 612, the user of the wireless device 106 receives the email message 502 and proceeds to disregard the message, read the message and/or delete the message. In the alternative described above, in step 612, the user may instruct the wireless device 106 to send a request to the email server 106 for additional portions of the email message 502. In step 614, the control flow of FIG. 6 stops.

FIG. 7 is an operational flow diagram illustrating a prior art process for wireless pull email delivery. The operational flow diagram of FIG. 7 shows a conventional process for delivering email messages to wireless devices using a pull method. The operational flow diagram of FIG. 7 begins with step 702 and flows directly to step 704.

In step 704, the email server 103 receives an email message, such as email message 502, intended for the user of wireless device 106. In step 706, the wireless device 106 is brought online or currently in contact with the wireless network 104 by the user. In step 708, if the user desires to receive email messages, then the user must instruct the wireless device 106 to send a request to the email server 106 for email messages.

In step 710, the email server 103 sends the entire email message 502 to the wireless device 106 via the wireless network 104. In one alternative, the email server 103 sends a first portion of the email message 502 to the wireless device 106 via the wireless network 104. Subsequently, if the user is interested in the email message 502, then the user must instruct the wireless device 106 to send a request to the email server 106 for additional portions of the email message 502.

In step 712, the user of the wireless device 106 receives the email message 502 and proceeds to disregard the message, read the message and/or delete the message. In the alternative described above, in step 712, the user may instruct the wireless device 106 to send a request to the email server 106 for additional portions of the email message 502. In step 714, the control flow of FIG. 7 stops.

FIG. 8 is an operational flow diagram showing an overall process of learning and implementation by an adaptive wireless email delivery process implemented in a wireless device, according to a preferred embodiment of the present invention. The operational flow diagram of FIG. 8 shows an overall process of how the adaptive wireless email delivery process of the present invention learns the email viewing interests of the user and proceeds to implement it. Note that the operational flow diagram of FIG. 8 describes an exemplary overall process of the adaptive wireless email delivery process, being implemented on a wireless device such as wireless device 106. The operational flow diagram of FIG. 8 begins with step 802 and flows directly to step 804.

In step 804, the adaptive wireless email delivery process of the present invention is placed in learning mode as it learns the email viewing interests of the user. Typically, this would occur when the adaptive wireless email delivery process is first executed, such as when a user first purchases the wireless device 106 including the adaptive wireless email delivery process of the present invention.

Next, in step 806, the wireless device 106 collects statistics associated with the user's email viewing habits and stores the information in the user email viewing interest database 110 in the wireless device 106. The user email viewing interest database 110 is a data repository for holding the statistics collected by the wireless device 106 in step 806. The statistics collected by the wireless device 106 are described in greater detail below.

In step 808, once the wireless device 106 has collected adequate information in the email viewing interest database 110, the adaptive wireless email delivery process of the present invention is placed in operating mode. In this mode, the wireless device 106 begins to make determinations as to whether the user of the wireless device 106 would be interested in receiving additional portions of email messages based on the information in the email viewing interest database 110.

In step 810, the wireless device 106 receives a first portion of an email message 502 from the email server 103. The first portion of the email message 502 may include only the first 1K or 2K of the email message 502 or simply include the header element 504 of the email message 502.

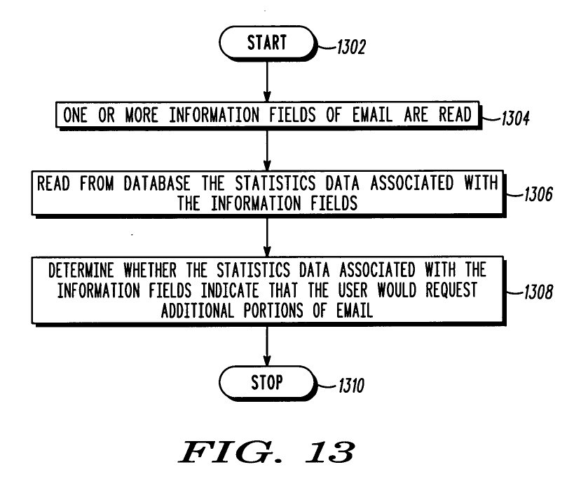

In step 812, the wireless device 106 determines whether the user of the wireless device 106 would be interested in receiving additional portions of the email message 502 based on the information in the email viewing interest database 110. More details regarding how the wireless device 106 determines whether the user of the wireless device 106 would be interested in receiving additional portions of the email message 502 are provided below with reference to FIG. 13.

In step 814, the wireless device 106 has determined that the user would be interested in receiving additional portions of the email message 502 based on the information in the email viewing interest database 1 10 and thus sends a request to the email server 103 for additional portions of the email message 502. In step 815, the wireless device 106 receives additional portions of the email message 502 from the email server 103. In step 816, the control flow of FIG. 8 stops.

In one embodiment of the present invention, the learning function of the wireless device 106 can continue after step 816. That is, after the wireless device 106 has been placed into operating mode, the wireless device 106 can continue to collect statistics associated with the user's email viewing habits and store the information in the user email viewing interest database 110 in the wireless device 106. The statistics collected by the wireless device 106 are described in greater detail below. In this embodiment, steps 806-815 of FIG. 8 are repeatedly executed as the cycle of collecting statistics and using the statistics to make the determination of step 812 continues.

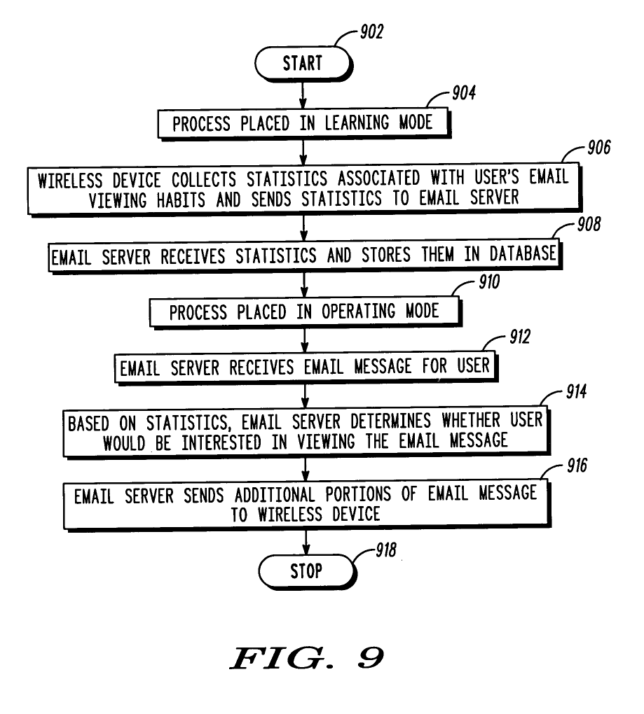

FIG. 9 is an operational flow diagram showing an overall process of learning and implementation by an adaptive wireless email delivery process implemented in an email server and wireless device, according to a preferred embodiment of the present invention. The operational flow diagram of FIG. 9 shows an overall process of how the adaptive wireless email delivery process of the present invention learns the email viewing interests of the user and proceeds to implement it. Note that the operational flow diagram of FIG. 9 describes an exemplary overall process of the adaptive wireless email delivery process, as it is implemented on an email server, such as email server 103. The operational flow diagram of FIG. 9 begins with step 902 and flows directly to step 904.

In step 904, an exemplary adaptive wireless email delivery process according to the present invention is placed in learning mode as it learns the email viewing interests of the user. This would occur, for example, on an ongoing basis when emails are received and the user either ignores a received email or takes specific actions on a received email such as opening the email, scrolling the email message, deleting the email, replying to the email, or requesting more portions of the email, according to an embodiment of the present invention.

Next, in step 906, the wireless device 106 collects statistics associated with the user's email viewing habits. In step 908, the wireless device 106 sends the collected statistics to the email server 103. The email server 103 receives the information and stores it in the user email viewing interest database 112. The user email viewing interest database 112 is a data repository for holding the statistics collected by the wireless device 106 in step 906. The statistics collected by the wireless device 106 are described in greater detail below.

In step 910, once the email server 103 has collected adequate information in the email viewing interest database 112, the adaptive wireless email delivery process according to an embodiment of the present invention is placed in operating mode. In this mode, the email server 103 begins to make determinations as to whether the user of the wireless device 106 would be interested in receiving additional portions of email messages based on the information in the email viewing interest database 112.

In step 912, the email server 103 receives an email message 502 intended for the user of the wireless device 106. In step 914, the email server 103 determines whether the user of the wireless device 106 would be interested in receiving additional portions of the email message 502 based on the information in the email viewing interest database 112. More details regarding how the email server 103 determines whether the user of the wireless device 106 would be interested in receiving additional portions of the email message 502 are provided below with reference to FIG. 13.

In step 916, the email server 103 has determined that the user would be interested in receiving additional portions of the email message 502 based on the information in the email viewing interest database 112 and thus sends additional portions of the email message 502 to the wireless device 106. In step 918, the control flow of FIG. 9 stops.

In one embodiment of the present invention, the learning function of the email server 103 can continue after step 916. That is, after the email server 103 has been placed into operating mode, the email server 103 can continue to collect statistics associated with the user's email viewing habits and store the information in the user email viewing interest database 112 in the email server 103. The statistics collected by the email server 103 are described in greater detail below. In this embodiment, steps 906-916 of FIG. 9 are repeatedly executed as the cycle of collecting statistics and using the statistics to make the determination of step 914 continues.

As explained above, the wireless device 106 collects statistics associated with the user's email viewing habits. These statistics are then stored in the user email viewing interest database 110 in the wireless device 106 (see FIG. 8) or the email viewing interest database 110 in the email server 103 (see FIG. 9). The user email viewing interest database 110 or 112 is a data repository for holding the statistics collected by the wireless device 106. These statistics are then used by the wireless device 106 or the email server 103 to determine whether the user of the wireless device 106 would be interested in receiving additional portions of the email message 502 based on the information in the email viewing interest database 110 or 112.

The information in the email viewing interest database 110 or 112, otherwise known as a user email viewing interest profile, associates a measure of a user's viewing interest with information (or key) fields of an email message. An email message includes a multitude of information or key fields. For example, the email message 502 (see FIG. 5) includes the following key fields associated with the transmission of the email message 502:

The name of the sender of the email message 502

the email address of the sender of the email message 502

the domain of the email address of the sender of the email message 502

the intended recipient of the email message 502

the subject of (or keyword in the subject of) the email message 502

the route that the email message 502 took during transmission to the recipient

the times associated with the location of the email message 502 at different times during transmission

The interest database 110 or 112 comprises one or more records, each record including a key field and corresponding data fields. A data field includes data associated with a measure of interest. The following are examples of information (that measures a user's viewing interest) that is included in a data field:

percentage of instances a user has requested a second portion of an email message

percentage of instances a user has scrolled through an email message

percentage of instances a user has replied to an email message

percentage of instances a user did not read an email message

percentage of instances a user deleted an email message

the number of additional portions of an email message that the user requested

As explained above, the present invention associates a measure of a user's viewing interest (i.e., data fields) with key fields of an email message 502. These associations are then used by the wireless device 106 or the email server 103 to determine whether the user of the wireless device 106 would be interested in receiving additional portions of the email message 502 based on the information in the email viewing interest database 110 or 112. These associations are included in at least one record. It should be noted that records are periodically monitored for senescence and discarded accordingly. That is, the records holding the association information described above are discarded when these records are not referenced or used for a certain period of time. Thus, when a record becomes stale, it is not used in the determination process.

In one example, a user is involved with a project at work and thus he immediately opens and requests additional portions of all email messages from his boss. Thus, with regards to the sender of these email messages (the user's boss), an exemplary embodiment of the present invention associates and stores the following data field information:

1) a high percentage of instances the user has requested a second portion of an email message from his boss,

2) a high percentage of instances a user has scrolled through an email message from his boss,

3) a high percentage of instances a user has replied to an email message from his boss,

4) a low percentage of instances a user did not read an email message from his boss and

5) the user always requested all remaining portions of the email messages from his boss.

A preferred embodiment according to the present invention associates the above data field information with the following key field information: the email address of the boss of the user. It can be seen that the above data field information indicates that the user has high interest in receiving additional portions of email message from his boss.

As a result, when the wireless device 106 or the email server 103 makes the determination of whether the user is interested in receiving additional portions of an email message from his boss based on the statistics collected and stored in the email viewing interest database 110 or 112, the stored information indicates that an email message from the user's boss is of high interest. The method in which the wireless device 106 or the email server 103 makes the determination of whether the user is interested based on the statistics in the email viewing interest database 110 or 112 is described in greater detail in FIG. 13.

In another example, a user has had a falling out with a friend and thus the user does not open his friend's email messages and does not request additional portions of email messages from his friend. Thus, with regards to the sender of these email messages (the user's friend), an exemplary embodiment according to the present invention associates and stores the following data field information:

1) a low percentage of instances the user has requested a second portion of an email message from his friend,

2) a low percentage of instances a user has scrolled through an email message from his friend,

3) a low percentage of instances a user has replied to an email message from his friend

4) a high percentage of instances a user did not read an email message from his friend and

5) the user never requested remaining portions of the email messages from his friend.

An exemplary embodiment according to the present invention associates the above data field information with the following key field information: the email address of the friend of the user. It can be seen that the above data field information indicates that the user has low interest in receiving additional portions of email message from his friend.

As a result, when the wireless device 106 or the email server 103 makes the determination of whether the user is interested in receiving additional portions of an email message from his friend based on the statistics collected and stored in the email viewing interest database 110 or 112, the stored information indicates that an email message from the user's friend is of low interest. An exemplary method in which the wireless device 106 or the email server 103 makes the determination of whether the user is interested based on the statistics in the email viewing interest database 110 or 112 is described in greater detail with reference to FIG. 13.

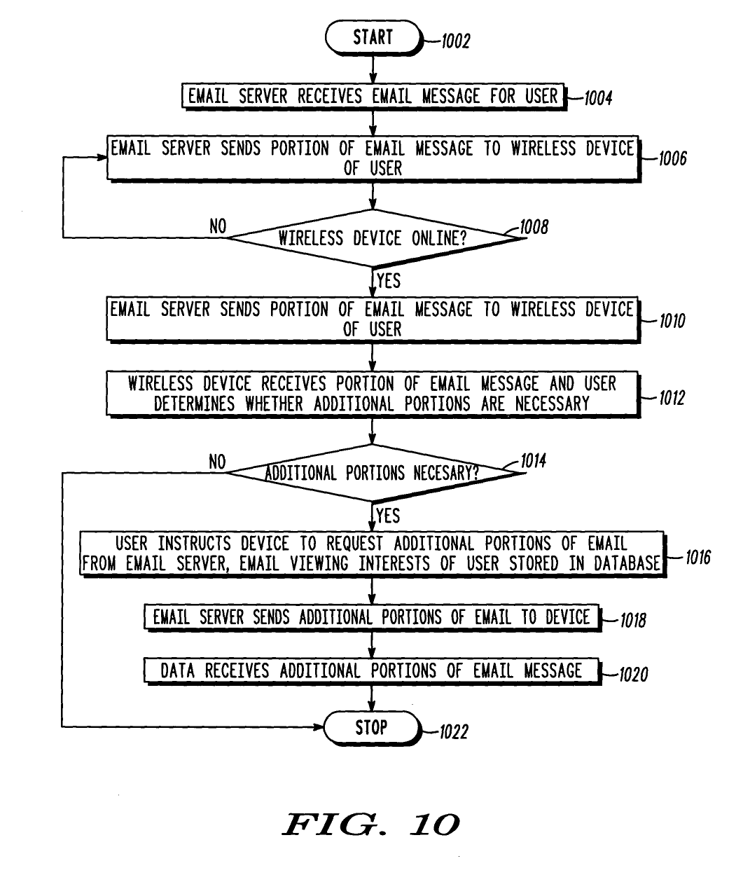

FIG. 10 is an operational flow diagram showing an exemplary process of learning by an adaptive wireless email delivery process, according to a preferred embodiment of the present invention. Note that the operational flow diagram of FIG. 10 describes the overall learning process of the adaptive wireless email delivery process, as it is implemented on either a wireless device, such as wireless device 106, or an email server, such as email server 103. The operational flow diagram of FIG. 10 begins with step 1002 and flows directly to step 1004.

In step 1004, the email server 103 receives an email message, such as email message 502, intended for the user of wireless device 106. In step 1006, the email server 103 determines whether the wireless device 106 is online or currently in contact with the wireless network 104. In step 1008, if the wireless device 106 is online or currently in contact with the wireless network 104, then control flows to step 1010. If the wireless device 106 is not online or currently in contact with the wireless network 104, then control flows back to step 1006.

In step 1010, the email server 103 sends a first portion of the email message 502 to the wireless device 106 via the wireless network 104. Subsequently, if the user is interested in the email message 502, then the user must instruct the wireless device 106 to send a request to the email server 106 for additional portions of the email message 502.

In step 1012, the user of the wireless device 106 receives the first portion of the email message 502 and determines whether he is interested in receiving additional portions of the email message 502. In step 1014, if the user is interested in receiving additional portions of the email message 502, the control flows to step 1016. If the user is not interested in receiving additional portions of the email message 502, the control flows to step 1022.

In step 1016, the user instructs the wireless device 106 to send a request to the email server 106 for additional portions of the email message 502. The wireless device 106 complies with the user instructions. In one embodiment of the present invention, also in step 1016, the wireless device 106 collects statistics associated with the user's email viewing habits. The statistics collected by the wireless device 106 are described in greater detail above. The wireless device 106 stores the information in the user email viewing interest database 110. The user email viewing interest database 110 is a data repository for holding the statistics collected by the wireless device 106.

In another embodiment of the present invention, also in step 1016, the wireless device 106 collects statistics associated with the user's email viewing habits. The statistics collected by the wireless device 106 are described in greater detail above. Then, the wireless device 106 sends the collected statistics to the email server 103. The email server 103 receives the information and stores it in the user email viewing interest database 112. The user email viewing interest database 112 is a data repository for holding the statistics collected by the wireless device 106.

In step 1018, email server 103 sends additional portions of the email message 502 to the wireless device 106. In step 1020, the wireless device 106 receives additional portions of the email message 502 from the email server 103. In step 1022, the control flow of FIG. 10 stops.

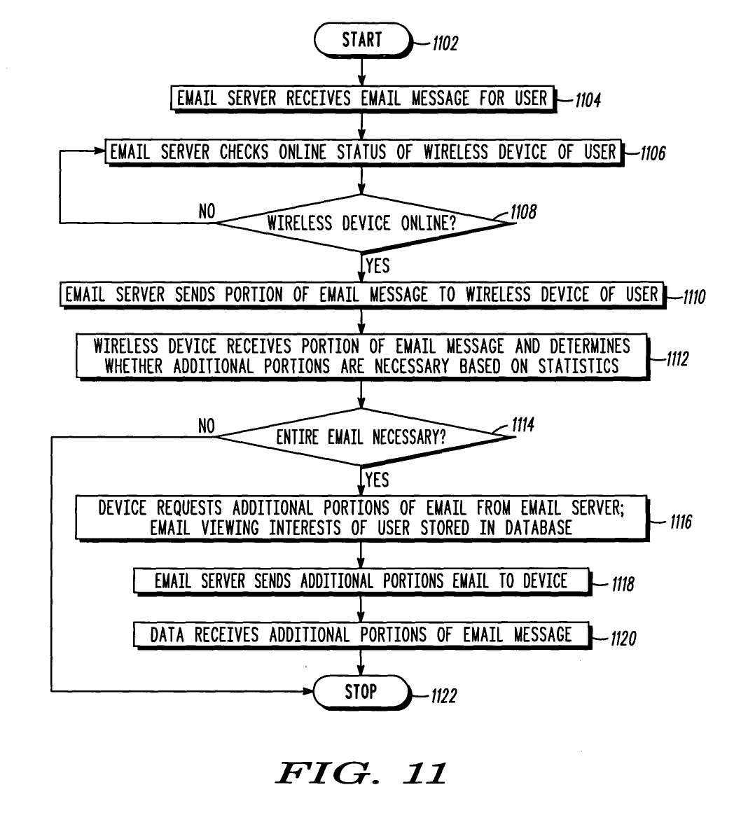

FIG. 11 is an operational flow diagram showing an adaptive wireless email delivery process implemented in a wireless device, according to a preferred embodiment of the present invention. Note that the operational flow diagram of FIG. 11 describes the overall process of the adaptive wireless email delivery process, as it is implemented on a wireless device, such as wireless device 106. The operational flow diagram of FIG. 11 begins with step 1102 and flows directly to step 1104.

In step 1104, the email server 103 receives an email message, such as email message 502, intended for the user of wireless device 106. In step 1106, the email server 103 determines whether the wireless device 106 is online or currently in contact with the wireless network 104. In step 1108, if the wireless device 106 is online or currently in contact with the wireless network 104, then control flows to step 1110. If the wireless device 106 is not online or currently in contact with the wireless network 104, then control flows back to step 1106.

In step 1110, the email server 103 sends a first portion of the email message 502 to the wireless device 106 via the wireless network 104. In step 1112, the wireless device 106 receives the first portion of the email message 502 and the wireless device 106 determines whether the user of the wireless device 106 would be interested in receiving additional portions of the email message 502 based on the information in the email viewing interest database 110.

In step 1114, if the user is interested in receiving additional portions of the email message 502, the control flows to step 1116. If the user is not interested in receiving additional portions of the email message 502, the control flows to step 1122 wherein the control flow of FIG. 11 stops. Subsequently, if the user is interested in the email message 502, then the user instruct the wireless device 106 to send a request to the email server 106 for additional portions of the email message 502.

In step 1116, the wireless device 106 sends a request to the email server 106 for additional portions of the email message 502. Embedded in the request is an indicator of the size and number of the requested additional portions of the email message 502. This is because the statistics associated with the user's email viewing habits collected by the wireless device 106 indicate a statistically representative size and number of requested additional portions of the email message 502.

Also in step 1116, the wireless device 106 collects statistics associated with the user's email viewing habits. The statistics collected by the wireless device 106 are described in greater detail above. The wireless device 106 stores the information in the user email viewing interest database 110. The user email viewing interest database 110 is a data repository for holding the statistics collected by the wireless device 106.

In step 1118, email server 103 sends additional portions of the email message 502 to the wireless device 106. In step 1120, the wireless device 106 receives additional portions of the email message 502 from the email server 103. In step 1122, the control flow of FIG. 11 stops.

In one embodiment of the present invention, the learning function of the wireless device 106 can continue after step 1118. That is, after the wireless device 106 has been placed into operating mode, the wireless device 106 can continue to collect statistics associated with the user's email viewing habits and store the information in the user email viewing interest database 110 in the wireless device 106. This operation would occur, for example, after step 1112. The statistics collected by the wireless device 106 are described in greater detail below. In this embodiment, steps 1104-1120 of FIG. 11 are repeatedly executed as the cycle of collecting statistics and using the statistics to make the determination of step 1112 continues.

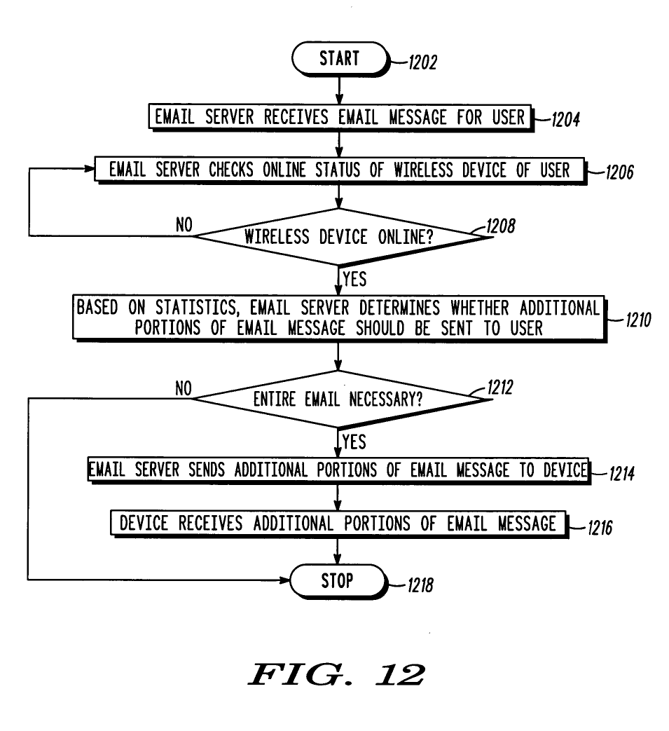

FIG. 12 is an operational flow diagram showing an adaptive wireless email delivery process implemented in an email server, according to a preferred embodiment of the present invention. Note that the operational flow diagram of FIG. 12 describes an overall adaptive wireless email delivery process, as it is implemented on an email server, such as email server 103. The operational flow diagram of FIG. 12 begins with step 1202 and flows directly to step 1204.

In step 1204, the email server 103 receives an email message, such as email message 502, intended for the user of wireless device 106. In step 1206, the email server 103 determines whether the wireless device 106 is online or currently in contact with the wireless network 104. In step 1208, if the wireless device 106 is online or currently in contact with the wireless network 104, then control flows to step 1210. If the wireless device 106 is not online or currently in contact with the wireless network 104, then control flows back to step 1206.

In step 1210, the email server 103 determines whether the user of the wireless device 106 would be interested in receiving additional portions of the email message 502 based on the information in the email viewing interest database 112. In step 1212, if the user is interested in receiving additional portions of the email message 502, the control flows to step 1214. If the user is not interested in receiving additional portions of the email message 502, the control flows to step 1218 wherein the control flow of FIG. 12 stops. Subsequently, if the user is interested in the email message 502, then the user must instruct the wireless device 106 to send a request to the email server 106 for additional portions of the email message 502.

In step 1214, email server 103 sends additional portions of the email message 502 to the wireless device 106. Note that the size and number of the additional portions of the email message 502 reflect information stored in the email viewing interest database 112. This is because the statistics associated with the user's email viewing habits collected by the wireless device 106 indicate a statistically representative size and number of requested additional portions of the email message 502. In addition to taking into account the statistics associated with the user's email viewing habits collected by the wireless device 106, the email server 103 also takes into the current traffic on the wireless network 104. Heavy network traffic may result in the transmission of smaller sized or fewer portions of email messages being sent to the wireless device 106, in order to conserve bandwidth during these peak times. Conversely, low network traffic may result in the transmission of larger sized or more portions of email messages being sent to the wireless device 106, since bandwidth is readily available.

In step 1216, the wireless device 106 receives additional portions of the email message 502 from the email server 103. In step 1218, the control flow of FIG. 12 stops.

In one embodiment of the present invention, the learning function of the email server 103 can continue after step 1216. That is, after the email server 103 has been placed into operating mode, the email server 103 can continue to collect statistics associated with the user's email viewing habits and store the information in the user email viewing interest database 112 in the email server 103. This operation would occur, for example, after step 1210. The statistics collected by the email server 103 are described in greater detail below. In this embodiment, steps 1204-1216 of FIG. 12 are repeatedly executed as the cycle of collecting statistics and using the statistics to make the determination of step 1210 continues.

FIG. 13 is an operational flow diagram showing a process for using a user email viewing interest database, according to a preferred embodiment of the present invention. The operational flow diagram of FIG. 13 shows the process of how the adaptive wireless email delivery process of the present invention determines whether the user of the wireless device 106 would be interested in receiving additional portions of the email message 502 based on the information stored in the email viewing interest database (110 or 112). Note that the operational flow diagram of FIG. 13 describes the determination process described above, as it is implemented on a wireless device, such as wireless device 106, or an email server, such as email server 102. The operational flow diagram of FIG. 13 begins with step 1302 and flows directly to step 1304.

In step 1304, information from one or more key fields of an email message is read. In the embodiment where the determination process is implemented on a wireless device, information from one or more key fields of a first received portion of an email message are read. As explained in more detail above, examples of information from one or more key fields of an email message 502 include the sender of the email message 502, the email address of the sender of the email message 502, the domain of the email address of the sender of the email message 502, etc.

Next, in step 1306, the data field information associated with the information from the key field read in step 1304 is retrieved from the email viewing interest database (110 or 112). As explained in more detail above, examples of data field information (i.e., measures of a user's viewing interest) that is detected and stored in association with data field information of an email message 502 include a percentage of instances a user has requested a second portion of an email message, a percentage of instances a user has scrolled through an email message, etc.

Next, in step 1308, based on the information in the email viewing interest database (110 or 112) it is determined whether the user of the wireless device 106 would be interested in receiving additional portions of the email message 502. In step 1310, the control flow of FIG. 13 stops. There are a variety of ways in which the information in the email viewing interest database can be used to calculate whether the user of the wireless device 106 would be interested in receiving additional portions of the email message 502.

One way to calculate whether the user of the wireless device 106 would be interested in receiving additional portions of the email message 502 based on the information in the email viewing interest database is to weigh each piece of data field information, sum all weights together and calculate whether the sum falls above or below a threshold.

In one example, a user is involved with a project at work and thus he immediately opens and requests additional portions of all email messages from his boss. Thus, with regards to the sender key field, the following data field information is retrieved from the email viewing interest database: 1) a high percentage of instances the user has requested a second portion of an email message from his boss, 2) a high percentage of instances a user has scrolled through an email message from his boss, 3) a high percentage of instances a user has replied to an email message from his boss 4) a low percentage of instances a user did not read an email message from his boss and 5) the user always requested all remaining portions of the email messages from his boss.

In this example, data fields 1)-5) above are weighted. Data fields 1), 2), 3), and 5) above are given positive weights since they indicate a user's interest in the email message. Data field 4) above is given a negative weight since it indicates a user's lack of interest in the email message. Then, all weights are added together to result in a single value. It is next calculated whether the sum falls above or below a threshold. It can be seen that in this example, the sum probably falls above a threshold and indicates that the user has high interest in receiving additional portions of email message from his boss.

The present invention can be realized in hardware, software, or a combination of hardware and software on the wireless device 106, the email server 103 or any combination of the two. A system according to a preferred embodiment of the present invention can be realized in a centralized fashion in one information processing system, or in a distributed fashion where different elements are spread across several interconnected systems. Any kind of information processing system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product that includes all the features enabling the implementation of the methods described herein, and which, when loaded in a system, is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A system may include, inter alia, one or more information processing systems and/or computers and at least a machine-readable or computer-readable medium, allowing a system, to read data, instructions, messages or message packets, and other information from the machine-readable or computer-readable medium. The machine-readable or computer-readable medium may include non-volatile memory, such as ROM, Flash memory, Disk drive memory, CD-ROM, and other permanent storage. Additionally, a machine-readable or computer-readable medium may include, for example, volatile storage such as RAM, buffers, cache memory, and network circuits. Furthermore, the machine-readable or computer-readable medium may include information in a transitory state medium such as a network link and/or a network interface, including a wired network or a wireless network, that allow a computer system to read such computer-readable information.

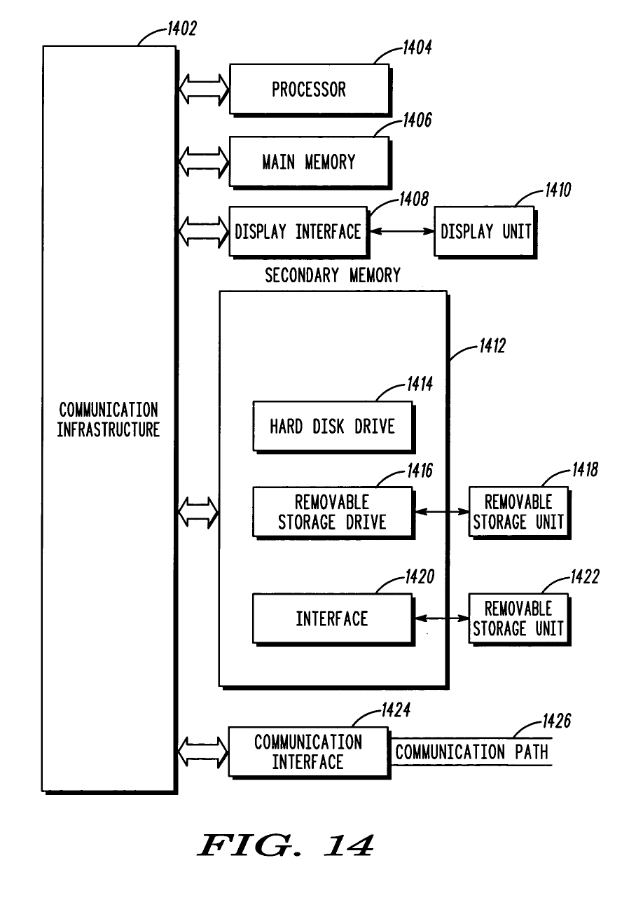

FIG. 14 is a block diagram of a computer system useful for implementing an embodiment of the present invention. The computer system of FIG. 14 includes multiple processors, such as processors 1404. The processors 1404 are connected to a communication infrastructure 1402 (e.g., a communications bus, cross-over bar, or network). At least one cache (not shown) is also connected to the communication infrastructure 1402. Various software embodiments are described in terms of this exemplary computer system. After reading this description, it will become apparent to a person of ordinary skill in the relevant art(s) how to implement the invention using other computer systems and/or computer architectures.

The computer system can include a display interface 1408 that forwards graphics, text, and other data from the communication infrastructure 1402 (or from a frame buffer not shown) for display on the display unit 1410. The computer system also includes a main memory 1406, preferably random access memory (RAM), and may also include a secondary memory 1412. The secondary memory 1412 may include, for example, a hard disk drive 1414 and/or a removable storage drive 1416, representing a floppy disk drive, a magnetic tape drive, an optical disk drive, etc. The removable storage drive 1416 reads from and/or writes to a removable storage unit 1418 in a manner well known to those having ordinary skill in the art. Removable storage unit 1418, represents a floppy disk, magnetic tape, optical disk, etc., which is read by and written to by removable storage drive 1416. As will be appreciated, the removable storage unit 1418 includes a computer usable storage medium having stored therein computer software and/or data.

In alternative embodiments, the secondary memory 1412 may include other similar means for allowing computer programs or other instructions to be loaded into the computer system. Such means may include, for example, a removable storage unit 1422 and an interface 1420. Examples of such may include a program cartridge and cartridge interface (such as that found in video game devices), a removable memory chip (such as an EPROM, or PROM) and associated socket, and other removable storage units 1422 and interfaces 1420 which allow software and data to be transferred from the removable storage unit 1422 to the computer system.

The computer system may also include a communications interface 1424. Communications interface 1424 allows software and data to be transferred between the computer system and external devices. Examples of communications interface 1424 may include a modem, a network interface (such as an Ethernet card), a communications port, a PCMCIA slot and card, etc. Software and data transferred via communications interface 1424 are in the form of signals which may be, for example, electronic, electromagnetic, optical, or other signals capable of being received by communications interface 1424. These signals are provided to communications interface 1424 via a communications path (i.e., channel) 1426. This channel 1426 carries signals and may be implemented using wire or cable, fiber optics, a phone line, a cellular phone link, an RF link, and/or other communications channels.

In this document, the terms “computer program medium,” “computer-usable medium,” “machine-readable medium” and “computer-readable medium” are used to generally refer to media such as main memory 1406 and secondary memory 1412, removable storage drive 1416, a hard disk installed in hard disk drive 1414, and signals. These computer program products are means for providing software to the computer system. The computer-readable medium allows the computer system to read data, instructions, messages or message packets, and other computer-readable information from the computer-readable medium. The computer-readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer-readable medium may include computer-readable information in a transitory state medium such as a network link and/or a network interface, including a wired network or a wireless network, that allow a computer to read such computer-readable information.

Computer programs (also called computer control logic) are stored in main memory 1406 and/or secondary memory 1412. Computer programs may also be received via communications interface 1424. Such computer programs, when executed, enable the computer system to perform the features of the present invention as discussed herein. In particular, the computer programs, when executed, enable the processor 1404 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method comprising:
storing a user's email viewing interest profile;
receiving a first portion of a wirelessly transmitted email message; and
wirelessly transmitting a request for transmission of a second portion of the wirelessly transmitted email message in response to determining that the stored user's email viewing interest profile indicates a user's interest in receiving a second portion of the wirelessly transmitted email message.

2. The method of claim 1, wherein the stored user's email viewing interest profile associates key field information of an email message with data field information, and wherein the determining comprises:
finding a match between key field information of the received first portion of the wirelessly transmitted email message and key field information in the stored user's email viewing interest profile.

3. The method of claim 1, further comprising:
wirelessly transmitting a request for wireless transmission of remaining at least one portion of the wirelessly transmitted email message in response to determining that the stored user's email viewing interest profile indicates a user's interest in receiving the remaining at least one portion of the wirelessly transmitted email message.

4. The method of claim 1, further comprising:
displaying the received first portion of a wireiessly transmitted email message.

5. The method of claim 1, wherein the stored user's email viewing interest profile comprises at least one of the following data field information:
percentage of instances a user has requested a second portion of an email message;
percentage of instances a user has scrolled through an email message;
percentage of instances a user has replied to an email message; and
percentage of instances a user did not read an email message.

6. A method comprising:
uploading to a central email server a user's email viewing interest profile;
storing the user's email viewing interest profile;
receiving an email message for the user; and
wirelessly transmitting a predefined portion of the email message in response to determining that the stored user's email viewing interest profile indicates a user's interest in receiving a predefined portion of the email message.

7. The method of claim 6, wherein the stored user's email viewing interest profile associates key field information of an email message with data field information, and wherein the determining comprises:
finding a match between key field information of the email message and key field information in the stored user's email viewing interest profile.

8. The method of claim 6, further comprising:
wirelessly transmitting remaining at least one portion of the email message in response to determining that the stored user's email viewing interest profile indicates a user's interest in receiving the remaining at least one portion of the email message.

9. The method of claim 6, wherein the stored user's email viewing interest profile comprises at least one of the following data field information:
percentage of instances a user has requested a second portion of an email message;
percentage of instances a user has scrolled through an email message;
percentage of instances a user has replied to an email message; and
percentage of instances a user did not read an email message.

10. A wireless device comprising:
a storage element for storing a user's email viewing interest profile;
a receiver for receiving a first portion of a wirelessly transmitted email message;
a processor for determining that the stored user's email viewing interest profile indicates a user's interest in receiving a second portion of the wirelessly transmitted email message; and
a transmitter for wirelessly transmitting a request for transmission of a second portion of the wirelessly transmitted email message, in response to the processor determining the indication of the user's interest in receiving a second portion of the wirelessly transmitted message.

11. The wireless device of claim 10, wherein the stored user's email viewing interest profile associates key field information of the email message with data field information, and wherein the processor finds a match between key field information of the received first portion of the wirelessly transmitted email message and key field information in the stored user's email viewing interest profile.

12. The wireless device of claim 10, wherein the processor further determines that the stored user's email viewing interest profile indicates a user's interest in receiving the remaining at least one portion of the wirelessly transmitted email message and the transmitter further wirelessly transmits a request for wireless transmission of remaining at least one portion of the wirelessly transmitted email message.

13. The wireless device of claim 10, further comprising:
a display for displaying the received first portion of a wirelessly transmitted email message.

14. The wireless device of claim 10, wherein the stored user's email viewing interest profile comprises at least one of the following data field information:
percentage of instances a user has requested a second portion of an email message;
percentage of instances a user has scrolled through an email message;
percentage of instances a user has replied to an email message; and
percentage of instances a user did not read an email message.

15. A computer readable medium including computer instructions for a wireless device, the computer instructions including instructions for:
storing a user's email viewing interest profile;
receiving a first portion of a wirelessly transmitted email message; and
wirelessly transmitting a request for transmission of a second portion of the wirelessly transmitted email message in response to instructions for determining that the stored user's email viewing interest profile indicates a user's interest in receiving a second portion of the wirelessly transmitted email message.

16. The computer readable medium of claim 15, wherein the stored user's email viewing interest profile associates a key field information of the email message with data field information, and wherein the instructions for determining comprises instructions for:
finding a match between key field information of the received first portion of the wirelessly transmitted email message and key field information in the stored user's email viewing interest profile.

17. A computer readable medium including computer instructions for a central email server, the computer instructions including instructions for:
uploading to the central email server a user's email viewing interest profile;
storing the user's email viewing interest profile;
receiving an email message for the user; and
wirelessly transmitting a predefined portion of the email message in response to instructions for determining that the stored user's email viewing interest profile indicates a user's interest in receiving a predefined portion of the email message.

18. The computer readable medium of claim 17, wherein the stored user's email viewing interest profile associates key field information of an email message with data field information, and wherein the instructions for determining comprises:
finding a match between key field information of the email message and key field information in the stored user's email viewing interest profile.

19. A system comprising:
a central email server for receiving an email message for a user, wirelessly transmitting a first portion of the email message to a wireless device of the user and receiving a request from the wireless device for transmission of a second portion of the wirelessly transmitted email message; and
a wireless device for storing a user's email viewing interest profile, receiving from the central email server a first portion of a wirelessly transmitted email message, determining that the stored user's email viewing interest profile indicates a user's interest in receiving a second portion of the wirelessly transmitted email message and wirelessly transmitting to the email server a request for transmission of a second portion of the wirelessly transmitted email message.

20. The system of claim 19, wherein the wireless device further determines that the stored user's email viewing interest profile indicates a user's interest in receiving a remaining at least one portion of the wirelessly transmitted email message and wirelessly transmits to the email server a request for wireless transmission of the remaining at least one portion of the wirelessly transmitted email message.

21. The system of claim 19, further comprising:
a user's email viewing interest profile for associating key field information of an email message with data field information, wherein the user's email viewing interest profile is periodically updated by the wireless device upon receipt of subsequent email messages.

22. The system of claim 21, wherein information in the user's email viewing interest profile is deleted when the information has not been referenced or used for a predetermined period of time.
